(19) United States
(12) Patent Application Publication
(10) Pub. No.: US 2003/0233307 A1
(43) Pub. Date: Dec. 18, 2003

(54) System and method for exchange and transaction processing for fixed income securities trading

(76) Inventors: Diarmuid Salvadori, Manly (AU); Lori A. Terry, Toronto (CA); Angela Lee, Scarborough (CA); Bill Hammond, Toronto (CA); Scott Colby, North York (CA); Eric Steinberg, Toronto (CA)

Correspondence Address: Orange & Chari, Suite 4900, 66 Wellington St. W., P.O. Box 190, Toronto, ON, M5K 1H6, CA

(21) Appl. No.: 10/170,433

(22) Filed: Jun. 14, 2002

(51) Int. Cl. G06F 17/60

(52) U.S. Cl. 705/37

(57) ABSTRACT

A fixed income securities trading framework for facilitating the negotiation and exchange of fixed income securities over an open network between a plurality of participants wherein, the trading framework comprises: a bond network having a search engine, a rule datastore, a pricing engine, a transaction engine and a fixed income securities database comprised a plurality of bids and offers; a pair of participants where at least one participant is a liquidity provider; and a datastore; wherein at least one of the search engine and the transaction engine correlates criteria defined by one of the participants to the bond database as requested by the participant and where at least one of the search engine and the transaction engine interact with the rules datastore on each of the participant request within the bond network; and wherein the bond network enables the participants to transact against one of a bid or offer posted in the fixed income securities database so as to facilitiate the exchange of fixed income securities between the participants.

### BACKGROUND OF THE INVENTION

1. Field of the Invention

The invention relates, in general, to a system and method of providing on-line fixed income securities trading, and more particularly, to facilitating the tracking, negotiation, and exchange of fixed income securities in a multi-user environment.

2. Description of the Prior Art

Fixed income securities are generally referred to as debt securities and actively traded, high-yield corporate notes. The present trading system involves person-to-person telephone exchanges wherein brokers often disseminate market information and current trade data while polling dealers for representative quotes.

A fixed income security is a certificate of debt issued by a government or corporation guaranteeing payment of the original investment plus interest by a specified future date. The face value of a fixed income security is the amount of money a company agrees to repay the fixed income security holder when the fixed income security matures. However, fixed income securities may trade at a discount or premium depending upon current market conditions, the movement of interest rates, and other factors. Further, some fixed income securities are callable, meaning that the issuer can elect to buy them back from holders before the date of maturity. Companies use the funds they raise from issuing debt fixed income securities for a variety of purposes, from building facilities to purchasing equipment to expanding the business. In essence, in buying a fixed income security, you are lending money to the corporation that issued it, which, in turn, agrees to return your money, or principal, on a specified maturity date and up until that time, the fixed income security also pays a stated rate of interest. There are a myriad of fixed income security types available such as: debenture fixed income securities, mortgage fixed income securities, collateral trust fixed income securities, equipment trust certificates, subordinated debentures, guaranteed fixed income securities, municipal fixed income securities, and fixed income security funds.

Fixed income securities tend to rise in value when interest rates fall, and fall in value when interest rates rise. Generally, the longer the maturity, the greater the degree of price volatility.

Yield and risk are key concepts in the fixed income securities market. Yield measures the return of one fixed income security against another and is the rate of return on a fixed income security investment. However, the yield on a fixed income security is not fixed, it changes to reflect the price movements in a fixed income security caused by fluctuating interest rates. Current yield is the annual return on the dollar amount paid for a fixed income security, regardless of its maturity. Yield to maturity is the total return received if a fixed income security is held until maturity. Typically, the periodic coupon payments on these fixed income securities are reinvested at the yield to maturity. Yield to maturity enables the comparison of fixed income securities having different maturities and coupons. Yield to maturity includes interest plus any capital gain realized or minus any capital loss suffered. Risk is generally posed by “call” and “refunding” provisions. If the fixed income security's indenture (the legal document that outlines a fixed income securities terms and conditions) contains a “call” provision, the issuer retains the right to redeem the debt, fully or partially, before the scheduled maturity date. A call feature creates uncertainty as to whether the fixed income security will remain outstanding until its maturity date. Owning a fixed income security with a call feature puts the investor at a disadvantage since the fixed income security may be called prior to maturity, creating reinvestment rate risk. Callable fixed income securities carry higher yields than noncallable fixed income securities so as to compensate the investor with a lower purchase price for the fixed income security and assuming the inherent risk associated with the reinvestment rate.

The current fixed income security trading system has several problems, namely the lack of real-time distribution of information on inventory availability and executable prices. In many cases, Daily Trade Bulletins depicting start of day pricing and inventory levels are distributed, but become quickly out of date. While the securities industry is populated with numerous means for on-line trading, the fixed income security market is lagging behind. Existing securities trading systems are not designed to effectively monitor and trade fixed income securities. Computerized tracking systems post trades, bids, quotes, etc facilitating the flow of information and improving reliability. U.S. Pat. No. 5,809,483 teaches a system for monitoring information relating to debt securities however, it provides no means to facilitate actual trading, meaning the buying and selling of bonds, this remains person to person. Ferstenberg in U.S. Pat. No. 5,873,071 teaches an electronic message exchange system to facilitate an intermediated exchange of financial commodities in a multi-user environment. The system employs a plurality of protocols according to the goals of a user and carries out negotiations through a round of messaging and is generally intended for the securities industry. The system provides no method of tracking the exchange of information, trades, or negotiations. Further, there is no central exchange of information that enables a user to search for bonds having a particular set of criteria.

It is an object of the present invention to obviate and mitigate at least some the aforementioned disadvantages of the prior art.

### SUMMARY OF THE INVENTION

It is accordingly a principal objective of the present invention to establish a system and method for the dynamic exchange of information and trading of fixed income securities between participants and liquidity providers. The fixed income securities trading system is preferably a web-based tool to aid firms trading in fixed income securities and their clients by providing information pertaining to market liquidity and price transparency and further a method of trade negotiation and order execution as it relates to the fixed income market. The system provides an interface for participants such as liquidity providers, clients (such as institutional clients, retail sales representatives, and external clients), and administrators so as to facilitate the online trading of fixed income securities. The system, in the preferred embodiment includes an interface with a third party fixed income security provider. In addition, the system further integrates with a back office system to facilitate trade settlements, bookkeeping, and trade related processing. The system may further include interfaces with, for example a portfolio management system, security data providers (such as providers of wider market information) and risk management so as to provide a complete analysis and trading platform however, these features are beyond the scope of the present invention.

The fixed income securities trading system, in the preferred embodiment comprises: at least two participants (a liquidity provider and a client) and fixed income security network having a pricing engine, rules datastore, search engine, transaction engine and fixed income securities database; at least one datastore for storage of transactional data, pricing data, and typically security and user privileges. Liquidity providers post bids and offers to the fixed income security database to provide bids and offers against particular fixed income securities in the trading system. Participants, for example external clients, transact against these posted bids and offers. The rules engine interacts with the transaction engine so as to provide for the enforcement of trading and compliance rules.

In operation, the search engine, in response to a request from a participant, queries the fixed income database for a resultant set of fixed income securities meeting the criteria as specified by the participant. On selection of the desired security, the transaction engine facilitates the order execution against posted bids and offers. The transaction engine interacts with the pricing engine during order execution to determine the price of the selected securities. The transaction engine further interacts with the rules datastore to ensure compliance with the pre-set system rules. In the preferred embodiment, on completion of a trade, the related trade files are sent to a back office for settlement and a record of the transaction is stored on the system such that the record is available for both reference or amendment.

The fixed income securities trading system, in the preferred embodiment, is used by one or more liquidity providers and one or more clients for the exchange of fixed income securities (or bonds) trading information and transaction execution. Liquidity providers post and maintain bids and offers using an electronic interface between the fixed income securities network and the liquidity provider's internal management system. Typically, the system also provides an interface for posting and maintaining bids and offers in the absence of an electronic link interface. To access the trading system over a public network such as the Internet, a participant, one of a liquidity provider or client, logs onto the system through an established and preferably secure session. The trading system determines the capabilities of the participant based on their logon name and capability information stored for the participant in the fixed income database. The participant selects an option from the available menu bar options, as determined by their capability information (e.g. bid/offer query, bid/offer maintenance, bond query, bond quotes, order query, order summary, or help) and the system returns the corresponding interface data screen. In the case when the participant elects to make a bid/offer query, the participant has the ability to specify fixed income security selection criteria such as: type of fixed income security, industry sector, issuer identifier, term to maturity range, coupon range, call feature, etc. The system, using the search engine, queries the fixed income database for bids and offers meeting the specified selection criteria. The search engine returns a resultant list of bids and offers meeting the criteria and the data is typically displayed in a summary view. In the preferred embodiment, the system dynamically updates modifications made to the resultant list of bids and offers so as to reflect data changes in real-time for example: price or quantity, best price bid or offer posted, etc such that the information is current.

The criteria for establishing the best-priced posting is customizable and may be determined on a site installation based on client specifications. Criteria may include but is not limited to lowest offer-side (highest bid-side) price, the highest bid-side (lowest offer-side) yield, time last updated, etc. Further, rules may be established to limit the number of bids and offers posted against a single fixed income security by a single source to protect against manipulation of marketplace prices.

From the resultant list of best-priced bids and offers, a participant may view the market depth namely, all the available bids and offers placed pertaining to a single fixed income security. An order entry may be initiated from a plurality of screens, including but not limited to the summary view and market depth view. When an order is placed, the system calculates the price, commission or trade fee, cost and yield. The system validates the order details to ensure the order as placed subscribes to the rules specified by the system. Further, the system is customizable so as to enforce predetermined company policies, for example: order size, commissions, spreads, yields, and inventory positions.

In the preferred embodiment, once logged on to the system, the participant navigates the different screens commonly using hyperlinks. The system enables a participant to search for fixed income securities having a specific set of criteria, view details relating to a specific fixed income security, create and maintain bid and offer postings, create and submit orders against bids and offers posted by liquidity providers, view a history of orders executed etc.

### BRIEF DESCRIPTION OF THE DRAWINGS

These and other features of the preferred embodiments of the invention will become more apparent in the following detailed description in which reference is made to the appended drawings wherein:

FIG. 1 is a schematic diagram of an overview of a computer system;

FIG. 2 is a schematic diagram further detailing the fixed income security trading in the computer system of FIG. 1;

FIG. 3 is a functional block diagram detailing the method for effecting a bond query and trade in the computer system of FIG. 1;

FIG. 4 is a detailed view of the bond query screen in the computer system of FIG. 1;

FIG. 5 is a detailed view of the bond depth screen in the computer system of FIG. 1;

FIG. 5a is a detailed view of a bond summary screen in the computer system of FIG. 1;

FIG. 6 is a functional block diagram detailing the method for effecting an order in the computer system of FIG. 1;

FIG. 7 is a detailed view of the order entry screen in the computer system of FIG. 1;

FIG. 8 is a detailed view of the order query screen in the computer system of FIG. 1;

FIG. 9 is a detailed view of the order summary screen in the computer system of FIG. 1;

FIG. 10 is a functional block diagram detailing the method for creating a bid/offer in the computer system of FIG. 1;

FIG. 11 is a detailed view of the bid/offer maintenance screen for creating a bid/offer in the computer system of FIG. 1;

FIG. 12 is a functional block diagram detailing the method for effecting a bid/offer query in the computer system of FIG. 1;

FIG. 13 is a detailed view of the bid/offer query screen in the computer system of FIG. 1;

FIG. 14 is a detailed view of a posting summary on the bid/offer maintenance screen in the computer system of FIG. 1;

FIG. 15 is a functional block diagram detailing the method for updating a posting in the computer system of FIG. 1;

FIG. 16 is a detailed view of the order details screen in the computer system of FIG. 1; and

FIG. 17 is a detailed view of an instruments detail screen in the computer system of FIG. 1.

Prior to the detailed description of the preferred embodiment, the following list of terms will be used in the context of the preferred embodiment to have the following meaning:

Client: refers to participants which transact against inventory items;

Trade: is the exchange of an inventory item between participants;

Bond Market: Fixed Income Security Market;

Depth of Market: a compilation of bids and offers on a particular fixed income security.

Liquidity Provider refers to a participant which creates inventory offerings;

### DESCRIPTION OF THE PREFERRED EMBODIMENTS

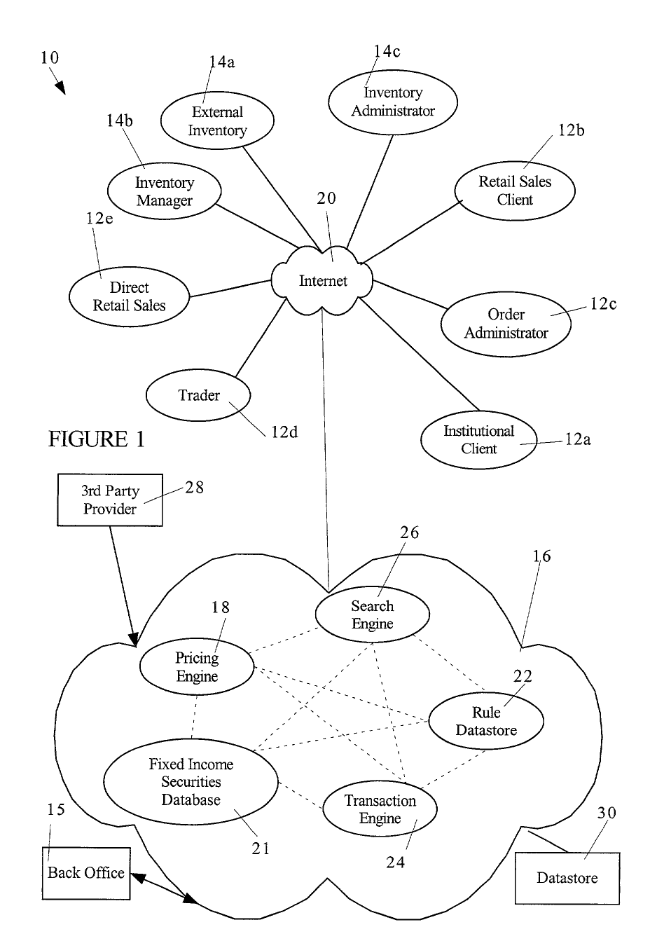

A system and method for establishing an exchange of information and facilitating the trading of fixed income securities between at least a pair of participants over an open network is illustrated in FIGS. 1 through 17. The computer system is generally designated by reference numeral 10. The system 10 may be configured in a number of different ways including those utilizing a plurality of individual participants as shown in FIG. 1.

As shown in FIG. 1, a fixed income securities trading system 10 comprises a plurality of participants namely liquidity providers 14 and clients 12, communicating over a communication system, such as the Internet 20, with a fixed income securities network such as bond network 16. The system allows the participants to perform transactions in fixed income securities using the network 16. The bond network 16 includes a pricing engine 18, a rules datastore 22, a search engine 26, a transaction engine 24 and a fixed income securities database 21 which are interconnected to one another for exchange of data within the network 16. Details 4 of the transactions completed in the network 16 are stored securely in a datastore 30. The system 10, in the preferred embodiment, further incorporates security features such as encryption, decryption, time out, etc. however, these features are well known in the art and will not be described in detail. It will be understood that although the present embodiment is shown with a bond network, other fixed income security networks for trading strips, GICs, or MBS may also be used.

The fixed income securities database 21 maintains an inventory of fixed income securities that have been posted by liquidity providers 14 and are thereby offered for trading. Clients 12 transact against this posted inventory through the bond network 16. The network 16 may include a link to a third party provider 28 of fixed income securities so as to offer liquidity providers a wider range of securities selection. Thus, in the event that the desired fixed income security is not found within the inventory offered on database 21, the network interfaces with the third party provider 28 to search a list of additional fixed income securities associated with the third party provider 28 for the desired fixed income security.

The participants are generally broken down into two basic groups, liquidity providers 14—those that create the inventory offerings within the system, and clients 12—those which transact against the inventory offered. A participant may function as both a liquidity provider 14 and a client 12 but for the purpose of the present description it will be assumed that each participant functions as a separate entity.

Clients 12 may be further broken down into a variety of subclasses each with their own characteristics. These subclasses are configurable on a site installation basis. There are two main client types—internal and external. An internal client is typically associated with the entity operating the bond network 16 and typically there are a plurality of internal clients associated with each entity operating the bond network 16. Examples of internal clients include retail sales clients 12b, traders 12d and order administrators 12c. A retail sales client 12b typically represents a particular financial institution, which uses the bond network 16 to create orders on behalf of their financial institution. An order manager, otherwise known as a trader 12d, represents a financial institution that uses the bond network 16 to monitor and approve orders against fixed income security inventory which they are managing. A trader 12d often places orders on behalf of a retail client and in some cases, places orders against inventory they are managing. In addition, a trader 12d may also act as a liquidity provider by offering inventory. An order administrator 12c has the same characteristics as a trader 12d however, they are not limited to a specific set of inventory and instead have full access to the bond network inventory.

An external client 12 differs from an internal client 12 in that whilst they may place orders they are not directly associated with an entity operating the bond network 16. For example, an institutional client 12a is an external client associated with an external financial institution. The institutional client 12a makes trades on behalf of their institution however, these trades are contracted through an internal client. A direct retail client 12e is a further type of external client that represents their own interests when facilitating trades however, these trades are also contracted through an internal client.

A liquidity provider 14 is also divided into subclasses. A liquidity provider 14 creates and manages inventory, offerings within the bond network. The liquidity provider is not an actual user of the bond network 16. There are two main types of liquidity providers—internal and external. An external inventory provider 14a is associated with an external financial institution that offers inventory. The external inventory provider 14a is able to create/update/delete inventory postings and has exclusive access to managing the pricing and quantities of their postings. An internal inventory manager 14b manages inventory of a particular product group (e.g. Corporate bonds) at the particular firm operating the bond network 16. An inventory administrator 14c is similar to an inventory manager 14b however, they are not limited to a particular product group.

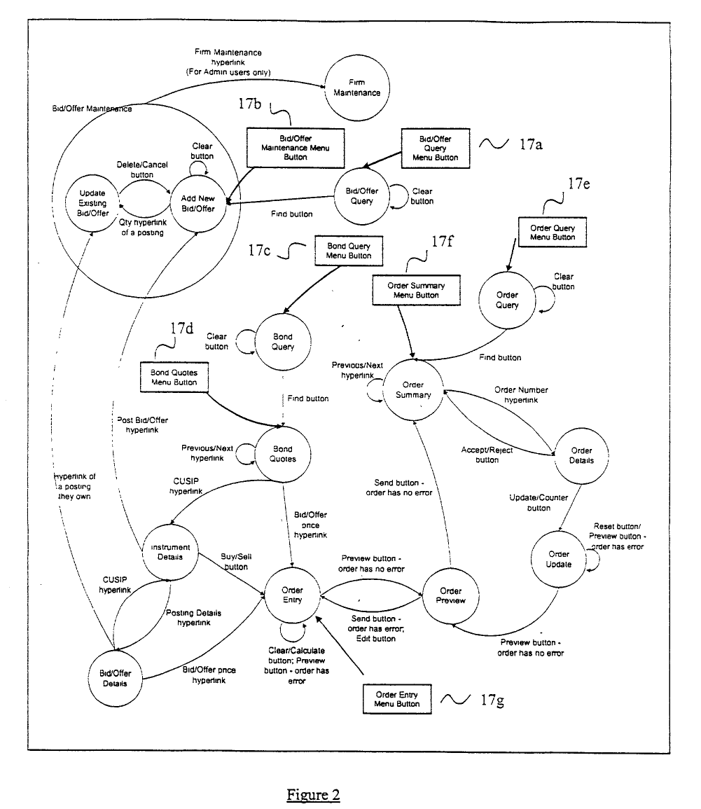

To access the system 10 over the Internet 20, a participant, one of a liquidity provider 14 or client 12, logs onto the system 10 through an established and preferably secure session. The participant 12,14 selects an option from the available menu bar options and the network 16 returns the corresponding interface data screen. The menu bar options available to the participant are based on the log in information provided by the participant. In this manner, client bar options are not available to liquidity providers and vice versa. FIG. 2 illustrates a detailed schematic of the bond network 16 which demonstrates the interaction and flow of information through the network 16. Participants navigate through a plurality of different interface data screens using a menu bar and preferably hyperlinks which are provided on individual screens. Menu bar options include but are not limited to bid/offer query 17a, bid/offer maintenance 17b, bond query 17c, bond quotes 17d, order query 17e, order summary 17f, order entry 17g and “Help” (not shown). The menu bar is configurable on a per installation basis. Individual components shown in FIG. 2 are discussed in more detail hereafter.

In general, the bond network 16, through a query from a participant, either liquidity provider 14 or client 12, returns a particular screen according to the data requested. When the system 10 is queried for information, the bond network 16 displays the corresponding screen. The bond network 16, as a result of the request, then prompts the search engine 26 to locate the requested information through interaction with the bond database 21 and typically at least one of the pricing engine 18, rules datastore 22 and/or transaction engine 24 so as to facilitate the exchange of information. A record of the transactions enacted by the system 10 is typically stored in datastore 30 in a secure environment. Particular data screens displayed by the system are dependent on the type or classification of the participant, as certain participants are not able to enact certain transactions. For example, an external inventory provider is not able to create an order or a new bid/offer and as such, those features are not available to that participant. Classification of participants may be by name, ID number, account number, or any means known to one skilled in the art.

In a typical application, a participant, such as a client, once logged on queries the network 16 for information pertaining to a fixed income security which they may wish to purchase. The participant enters a set of search criteria which define the required parameters of the security they wish to purchase. On inputting this criteria the system then queries the fixed income security database 21 and returns a listing of the securities that have those specified parameters and are available for purchase. Alternatively, on selection of the bond quotes feature 17d, the network displays a list of all bonds listed in the bond database 21 available for trading to the current participant. The participant then typically selects the particular fixed income security of interest and places an order for same though the order entry screen. The participant enters details of the order specifying that they are making a bid and the quantity desired. The process for bidding and asking are performed using similar methods. Once the participant inputs these details, the network 16 amends the database 21 to post the transaction. At this point, the listing of securities a participant would find on performing a subsequent bond query would indicate a reduced quantity in the fixed income security for which the participant has placed an order. Once the details of the order are posted by the system, the trade is considered to have been enacted and the trade is subsequently settled in the back office 15 in a normal manner. After placing a number of orders, either an offer to sell, which indicates the price the participant is willing to accept for a security, or an offer to buy, which indicates the price at which a participant is willing to buy a security for, a participant may wish to review their bid/offers in order to evaluate their holdings. This is done through either the bid/offer query feature which in general permits a search against a number of selectable criteria or the order query feature which is specific to particular orders. Additionally, if the participant has offered a particular security and wishes to change for example the price at which that security is offered, the participant may update and modify this posting through the bid/offer maintenance feature. The system enables the participant to easily navigate through the different features through the input of participant defined queries.

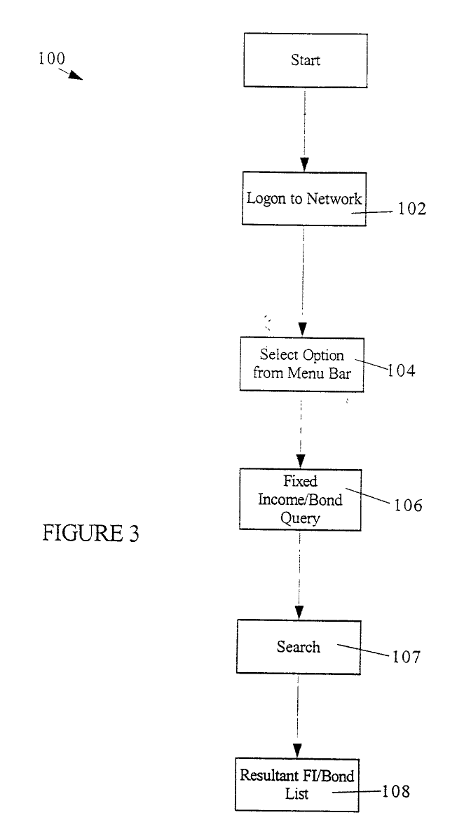

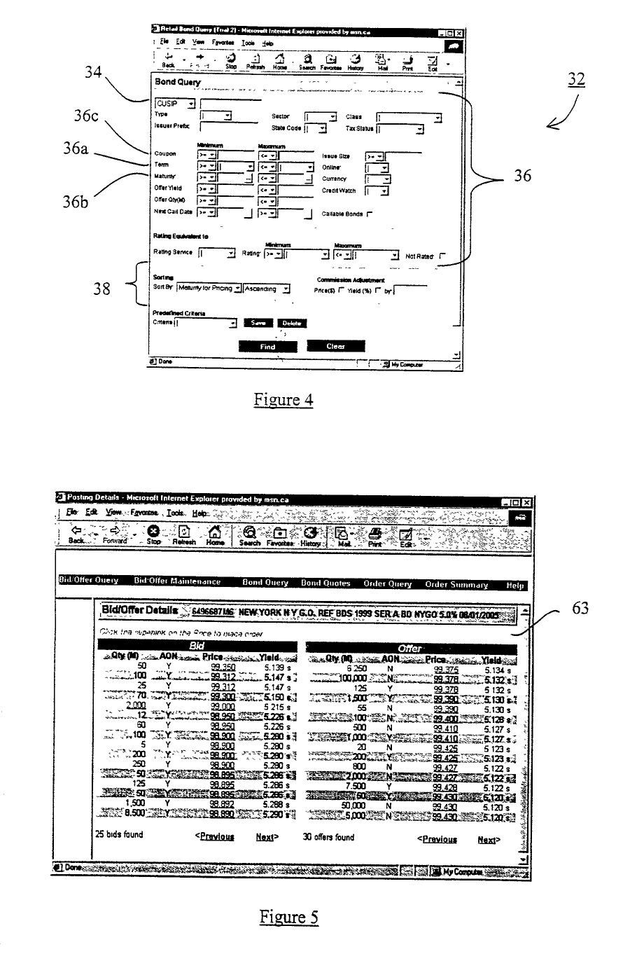

A method of effecting a bond query is shown in more detail in FIG. 3. A participant logs onto the system 10 by forming a connection with the bond network 16 and passing through security features, known to one skilled in the art, requiring identification of the participant. Once logged on 102, the participant 12, 14 selects an option from the available menu bar options 104 detailed in FIG. 2. These options include but are not limited to bid/offer query 17a, bid/offer maintenance 17b, bond query 17c, bond quotes 17d, order query 17e, order summary 17f and order entry 17g. As detailed in FIG. 3, the participant in this case selects as indicated at 106 the menu item bond query which returns a bond query screen 32 as shown in FIG. 4. The screen 32 enables the participant to specify search criteria 36 shown on the screen pertaining to bond type and filter the resulting number of bonds found.

Typically, a participant is looking to transact (buy or sell) particular fixed income securities that meet a specific set of criteria. The bond query screen 32 enables the participant to specify those search criteria 36, which may include but are not limited to: term 36a, maturity 36b, coupon rate 36c etc. These search criteria are related to the various parameters of a fixed income security and are specified by the party issuing the bond. Additionally, the participant may further specify sorting criteria 38 which details the manner in which the resulting list of bonds are displayed. An example of a sorting criteria is by ‘maturity for pricing’ where the bonds are sorted according to the date on which they mature. Alternatively, the participant may specify a unique identifier 34 associated with each bond that fully defines the bond of interest.

Once the participant has entered the desired search criteria 36, the network 16 instructs, at 107, the search engine 26 (shown in FIG. 1) to interact with the bond database 21 and search for fixed income securities that meet the search criteria 36. When the search is complete, the system returns, at 108, a resultant bond/fixed income securities list 98 as illustrated in FIG. 4a in the content section 97 of the bond quotes screen 96. The bond list reveals information about the fixed income securities that meet the search criteria in a predetermined format. In the preferred embodiment, the bond list reveals for each bond listed the best bid and offer price to date. Preferably, the bond list 98 is periodically updated to reflect ongoing changes in offerings pricing and quantity of securities availing in response to tradings, posting and administrative transactions being applied by participants. Typically, when the system returns a bond list 98, each inventory item on that list has a unique identifier 34. This identifier 34 allows the system to track bid/offer transactions and bond queries against each particular inventory item. In the event that no bonds are found when performing a bond query, the network 16 returns a message in the content section 97 of the bond quotes screen 96 stating “no record found”. When no search criteria 36 is entered, the network returns all inventory items that are available for viewing by the current participant.

When entering the desired search criteria on the bond query screen 32 shown in FIG. 4, to facilitate repetitive use, a participant may save the criteria specified for subsequent use. The participant enters a name 39 under which the criteria currently specified will be saved and the system 10 stores this data for future use either in the network 16 or in the participant's terminal. When a participant logs on to the system, they may retrieve the list of predefined criteria. Further, the participant may also elect to add new, update, and delete the existing criteria.

A further feature of a bond query is the ability of the participant to view all the bids and offers related to a particular bond as will be explained below. A bond list 98 as shown in FIG. 4a results from a participant enacting a bond query, as described above, and will reveal one or more fixed income securities in the inventory that meets the specified search criteria. The list of fixed income securities illustrates the best bid price 94 and best offer price 95 currently posted against each of the inventory items listed. However, a participant may want to obtain a full history of all bids and offers posted against a particular bond. In order to obtain further details relating to a particular bond, the participant selects a particular bond from the bond list through the market depth icon 99 for that particular bond.

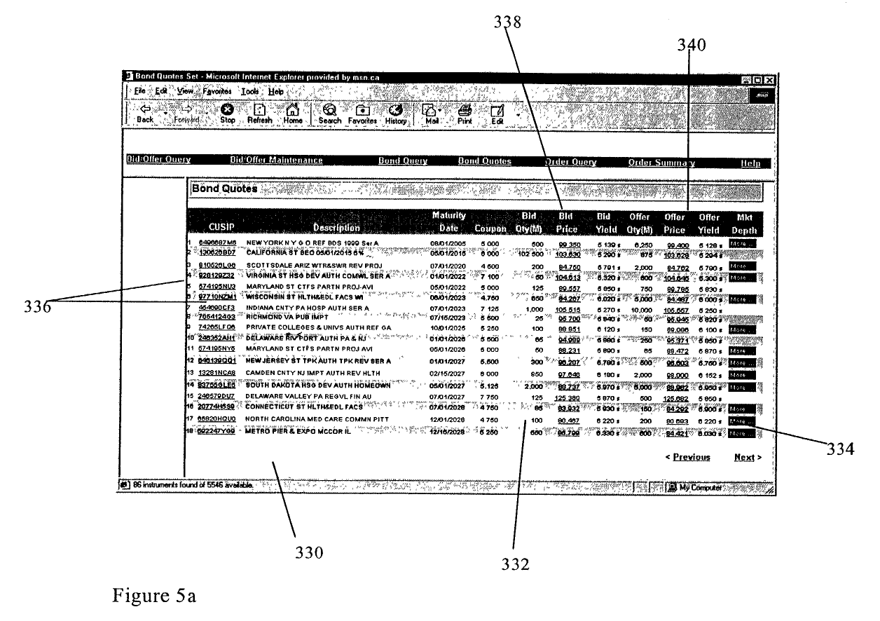

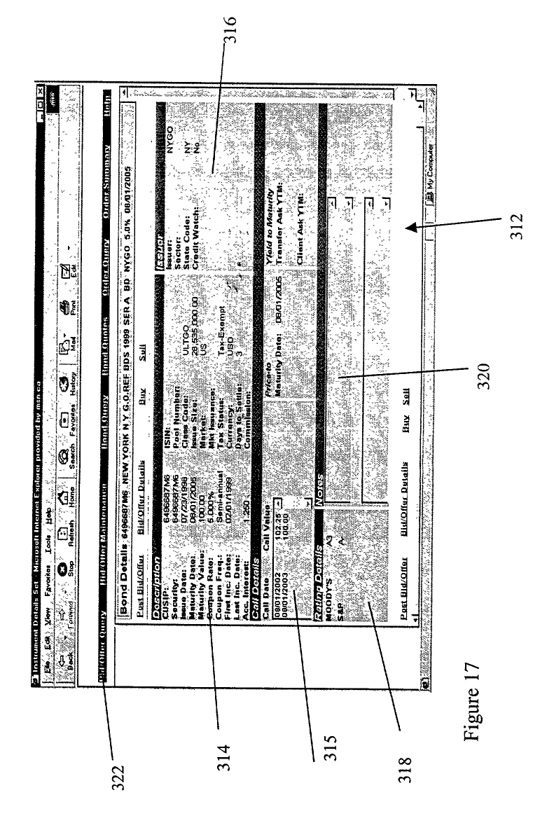

A participant may also want to view detailed information relating to a particular fixed income security. On selecting the CUSIP hyperlink for a particular security, the network 16 displays the instrument details screen (as schematically shown in FIG. 17) which illustrates a detailed description for the fixed income security. For example, information about the bond issues, bond rating, bond call details etc. are viewed by the participant. These features of the fixed income security are pre-set by the issuer and are displayed in “read-only” format. On selection of an inventory item, the network 16 interrogates the database 21 and returns a bond depth listing 63 as shown in FIG. 5. This listing details all bids/offers posted against the particular bond selected and prior transactions for that bond that have been conducted on the network 16, on the bid/offer details screen. Accordingly, the depth of the market for a particular bond is provided which enables a participant to review the current status of a particular bond prior to transacting against that bond. It will be understood that this may apply not only to bonds but to any security.

FIG. 5a provides a bond summary screen which displays bond summary information. The screen 330 provides a list 332 of quotes for different bonds. By selecting a more button 334, participants may also access a detail view of the selected bond and a listing of all bids and offers posted against the selected bond available for trading. Each row 336 within the list 332 represents data for a single bond. Any bid side information 338 refers to the best-price bid posted against the instrument while any offer side information 340 refers to the best-price offer T posted against the instrument. If no bid or offer exists for an instrument, the corresponding bid side information 338 or offer side information 340 fields (e.g. quantity, price and yield) is blank. Although the bond summary screen of the present embodiment display twenty rows of records, it will be understood that this number may be changed. From the bond summary screen 330, an instrument details screen, as shown in FIG. 17, may be accessed. The instrument details screen 312 is used to provide users with a detailed view of a selected security. In the present embodiment, the instrument details screen 312 is used to display information such as a description of the security 314, call details of the security 315, issuer of the security 316, rating details of the security 318 and notes concerning the security 320. A menu bar 322 allows the participant to access the bid/offer query 17a, bid/offer maintenance 17b, bond query 17c, bond quotes 17d, order query 17e, order summary 17f or help 312. It will be understood that the menu bar may provide other options and is not limited to those displayed in FIG. 17.

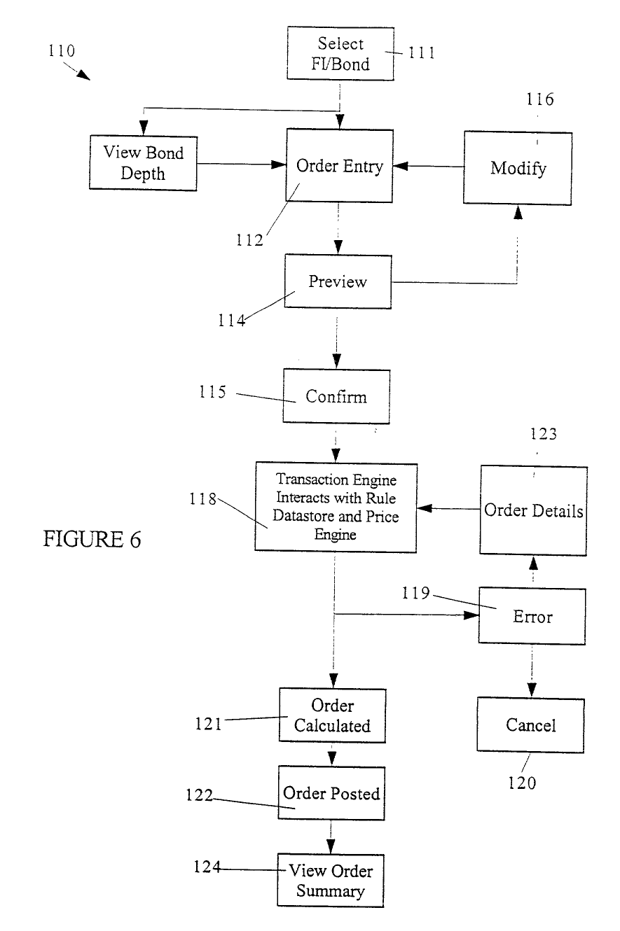

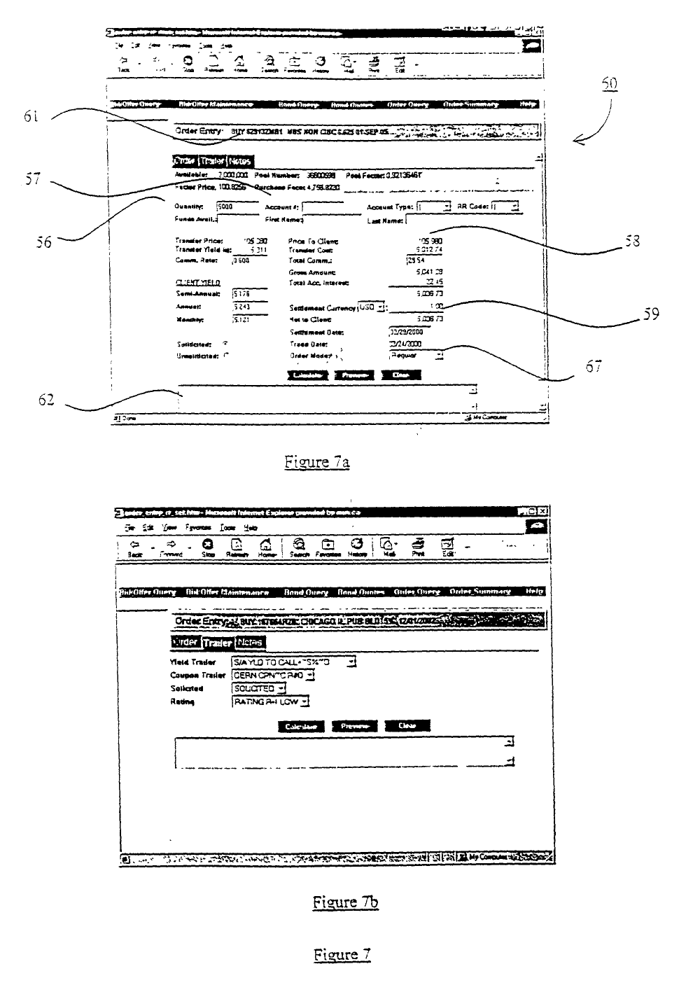

A method of effecting an order 110 for a particular fixed income security e.g. bond is detailed in FIG. 6. To create an order, the participant may first select a bond 111, generally from the bond list 98 generated from a bond query as described above and then selects the “new order” icon on the screen (not shown). Alternatively, a participant may select “order entry” 17g directly from the menu bar as shown in FIG. 2. The system returns the order entry screen in both cases detailed in FIG. 7.

When placing an order, after selecting a bond to transact against, the participant is prompted to enter details on the order entry screen illustrated in FIG. 7. Specifically, FIG. 7a enables the participant to enter bond details and personal account information. FIG. 7b shows a trailer tab portion of the order entry screen which is typically for use by retails sales clients and traders. Trailers tabs are divided into groups and a participant may select a particular trailer tab on entering an order. The trailer tab specifies the format that the order information will be displayed once a trade has been enacted. For example, a participant may select to display the particular yield formula applied to the security, and the coupon rate.

The order entry screen enables a participant to enter order information such as whether they wish to buy or sell 61, order quantity 56, account number 57 etc. After selecting a bond, the participant is prompted at the order entry screen shown in FIG. 7a to enter the order details and create an order 112. The current price of the bond selected is displayed in the ‘price to client’ field 58. A participant may create a buy offer, bid side, against the best priced offer posted for a bond or a sell order, offer side, against the best priced bid posted for a bond. Following the completion of an order, the participant selects one of the preview 114 or calculate 116 buttons on the order entry screen 60 and the network 16.

Upon selection of either button 114 or 116, the orders are sent by the network 16 to the transaction engine 24 which interacts 118 with pricing engine 18 and the rules datastore 22 to calculate the current price of the order 121 and to ensure the order does not violate any rules specified by the system. In the case of the preview button 114, a preliminary validation of the order data is performed via various calculations on the order data. In the case of the calculate button 116, orders not in violation of any rules are posted 122 against the specified bond.

On selecting the feature, if the participants want to edit 115 an order detail, the participant is returned to the order entry screen and the order details may then be modified. The order preview screen is similar to the order entry screen except that it is read-only.

If on previewing or calculating the order, the rules datastore 22 prompts the system to return an error 119, the participant is returned to the order entry screen 60 shown in FIG. 7a and an error message is displayed in the content section 62 of the order entry screen 60. Here, the order may be 119, modified and corrected 123 or cancelled 120. As shown in FIG. 6, on confirming the order details at 115, the transaction engine 24 interacts with the pricing engine 18. The pricing engine 18 determines the total net price to the participant associated with the order created. The pricing engine uses a pricing algorithm and pricing method, each of which are specific to the particular fixed income security. Each of the pricing algorithm and method is specified by one of the bond issues or the participant offering the bond for trade. The pricing engine has at least one pricing method including but not limited to, benchmark relationship, curve and spread set, and direct price or yield and at least one pricing algorithm including but not limited to, price to call date, price to maturity date and price to worst date. In calculating a price or yield value, the pricing engine accesses a pricing library consisting of one or more price/yield formulae to derive both bid and offering side pricing. In addition, both the transaction engine 24 and pricing engine 22 interact 118 with the rules datastore 22 to ensure the order placed does not violate any rules specified by the system 10. For example, when a minimum order quantity is specified for a bond, an error is generated if the order quantity selected by the participant is less than the minimum value specified. If the rules datastore 22 prompts the system to return an error 119, the participant is returned to the maintenance order entry screen 60 shown in FIG. 7a where the order may be modified 123 to correct the error or cancelled 120. When a new order created does not violate any system rules, the network 16 calculates a price and/or yield value 121 depending on the initial information entered. The new order is then posted 124 by the system against the specified bond and the posting is stored. On posting an order, the system returns the participant to the order summary screen where the specifics of the order may be viewed. When a posting is successfully created, the system adds the order posted to the portfolio of fixed income securities owned by that specific participant.

Once an order is posted the trade has been enacted and the system 10 returns an order summary screen where order details are viewed 124. The order summary screen 90 illustrated in FIG. 9 updates automatically as orders are placed. The order summary screen 90 illustrates all orders placed by the participant or orders that have been placed against a participant's postings. A record of an order that has been posted is saved in datastore 30 (shown in FIG. 1). The trade is settled by a back office 15 (shown in FIG. 1) independent from the bond network 16.

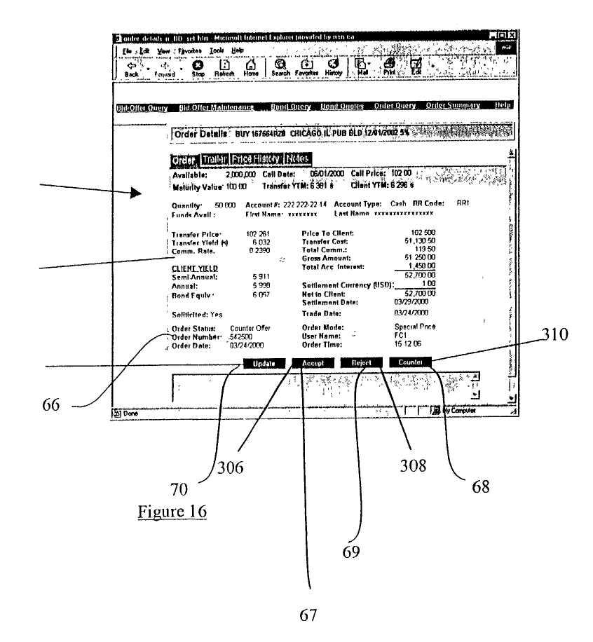

From the order summary screen 90, a participant on selecting the ‘order number’ hyperlink 92 shown in FIG. 9, the system is prompted to return to an order details screen as shown in FIG. 16. The order details screen allows a participant to view orders which they are a party to. Further, when viewing an order created by themselves, the participant may update order details such as the account number, customer name, etc. The order summary screen may be periodically updated to reflect changes in the state of various orders.

In one embodiment of an order details screen 300, as shown in FIG. 16, the screen provides a menu bar allows the participant to access the bid/offer query 17a, bid/offer maintenance 17b, bond query 17c, bond quotes 17d, order query 17e, order summary 17f or help 312. It will be understood that the menu bar may provide other options and is not limited to those displayed in the present embodiment. The screen 300 further provides a status information section 302 which includes information such as the order number, the order status and the order date and time and an update button 304 which allows a participant to access an order update screen to update the order. The screen 300 further provides accept 306, reject 308 or counter 310 buttons for implementing a price negotiation feature, as will be described below.

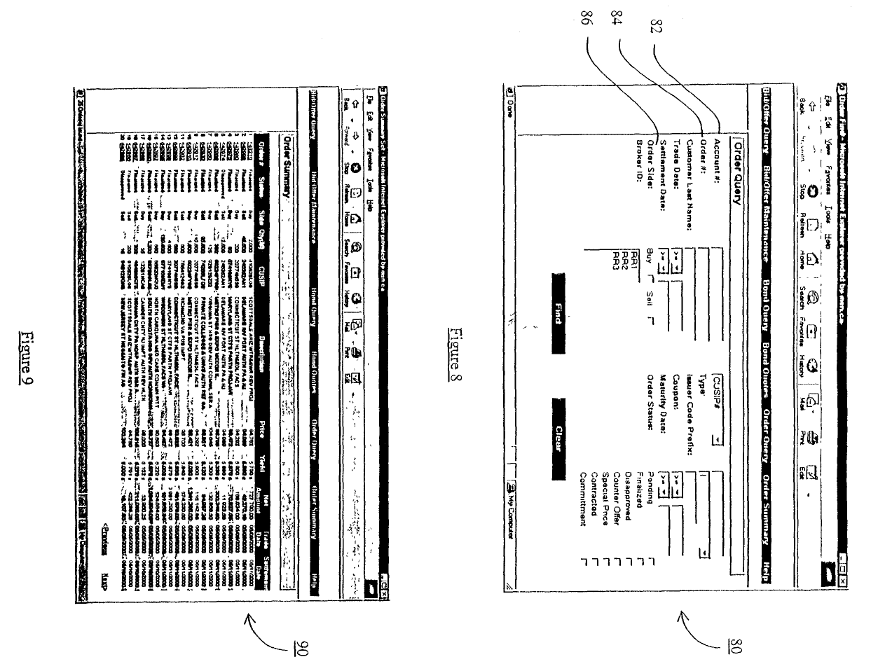

A participant having placed a plurality of orders can search for information regarding an order placed by that participant or an order placed against a bid/offer created by that participant through the selection of the order query menu item 17e shown in FIG. 1. The system returns the order query screen 80 as shown in FIG. 8 and the participant enters the search criteria pertaining to the desired order such as: the account number of the order 82, order number 84, order side 86 (bid/offer), etc. On inputting the criteria for the order, the network 16 prompts the search engine 26 to locate any orders meeting the search criteria specified. The results of the search are displayed in the content of section 91 an order summary screen 90 shown in FIG. 9. In the event that no orders are found meeting the specified search criteria the system 10 displays the message “No Orders Found” in the content section 91 of the screen 90.

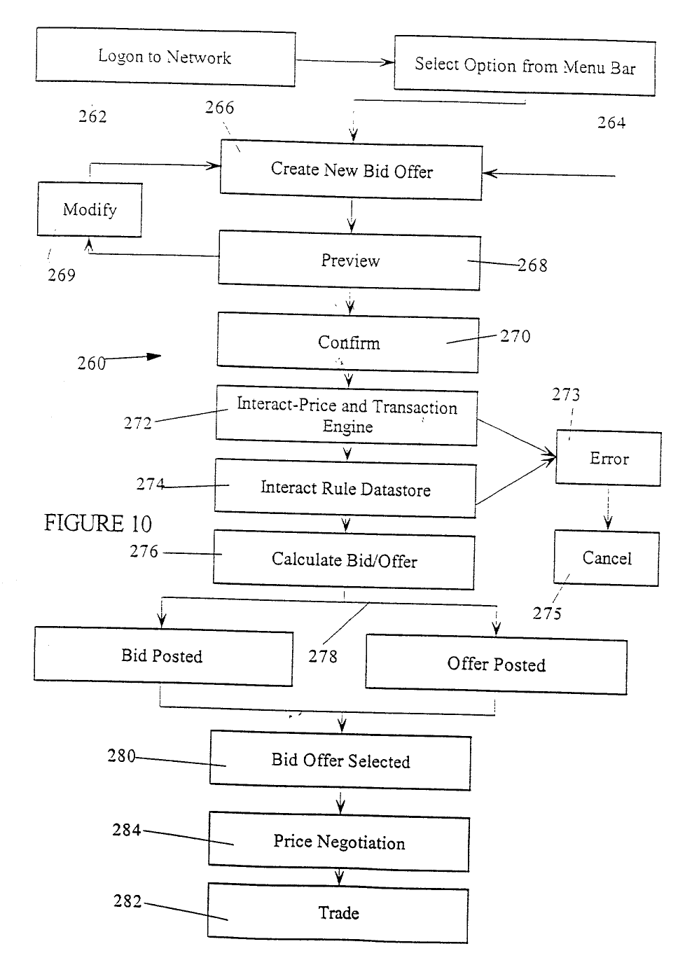

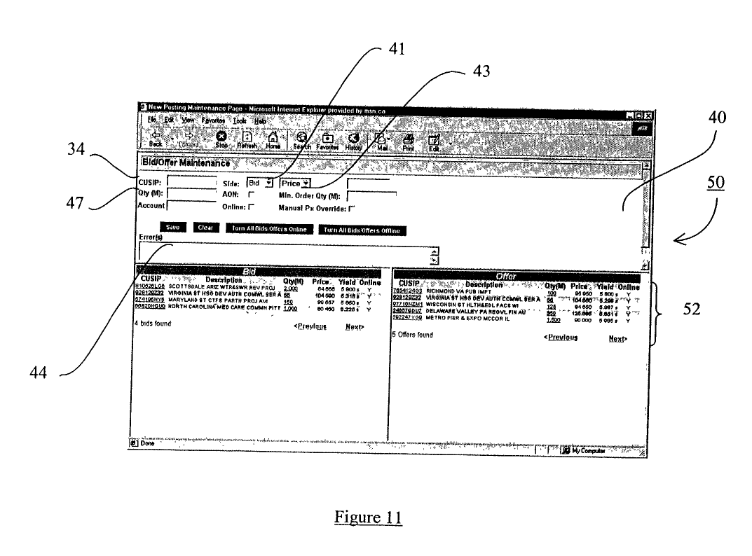

The system also enables a participant, preferably a client, to place bid/offers through a bid/offer maintenance screen illustrated in FIG. 11. This enables a particular participant to view bids and offers under his control rather than individual bonds available for viewing. A method of creating a bid/offer is detailed in FIG. 10. The participant logs onto the system at 262 and passes through security features requiring the identification of that participant by any means known to one skilled in the art. Once logged onto the system, the participant selects an option 264 from the available options on the menu bar detailed in FIG. 2. The participant in this case selects bid/offer maintenance which enables the participant to create a new bid/offer. The bid/offer maintenance screen includes an order placement area 40 and a current bid/offer listing area 52.

In creating the new bid or offer 266, the system returns to the participant a Bid/Offer Maintenance screen as shown in FIG. 11 with a blank order placement area 40. The participant is prompted by the system to enter the particulars relating to the fixed income security of interest. Each fixed income security has a unique identifier 34, such as a CUSIP, an ADP number or an ISIN, assigned thereto used to identify the security within the bond network 16. The participant enters the unique identifier associated with the bond 34, specifies the side 41 e.g. a bid or an offer, and selects one of either the price or yield 43 and enters the quantity of fixed income security desired 47. The process then continues in a manner similar to the creation of an order outlined above and detailed in FIG. 7. Following the completion of the new bid/offer entry, the system returns 268 a preview screen that is typically read-only. The participant reviews the preview of the bid/offer created to ensure that details entered are correct. The preview screen enables the participant to either accept 270 or reject the new bid/offer.

If a particular feature of the new bid/offer is in error, the participant rejects the bid/offer and the system returns the participant to the bid/offer maintenance screen 269 and parameters of the bid/offer may be modified. As shown in FIG. 10, on confirming 270 the bid/offer details, the transaction engine 24 interacts 272 with the pricing engine 18. In addition, both the transaction engine 24 and pricing engine 22 interact with the rules datastore 22 to ensure the bid/offer created does not violate any rules 274 specified by the system 10. When no error is found, a price is calculated 276 for the bid/offer, as described above in relation to an order placed. The new order is then posted 278 by the system against the specified bond and the posting is stored. If the rules datastore 22 prompts the system to return an error 273, the participant is returned to the bid/offer maintenance screen and a message is displayed in the error content section 41 of the screen. The participant may opt to modify and correct 269 the error or cancel 275 the order.

On posting a bid/offer, the system returns the participant to the bid/offer details screen, shown in FIG. 5 where the specifics of the bid/offer created may be viewed. When a posting is successfully created, the system adds the bid/offer posted and/or order posted to the portfolio of bid/offers owned by that specific participant. Therefore, when the participant elects to perform a bid/offer query to view all their bid/offers created, the new bid/offer will be illustrated in the postings summary for that participant. The accepted bid/offer may also be viewed by other participants via the bond summary screen of FIG. 5a. Once a bid/offer is posted by the system, that bid/offer may be selected 280 by another participant such that a trade is enacted 282 as shown in FIG. 10. The other participant enacts a trade by placing a bid/offer or order against the fixed income security posted.

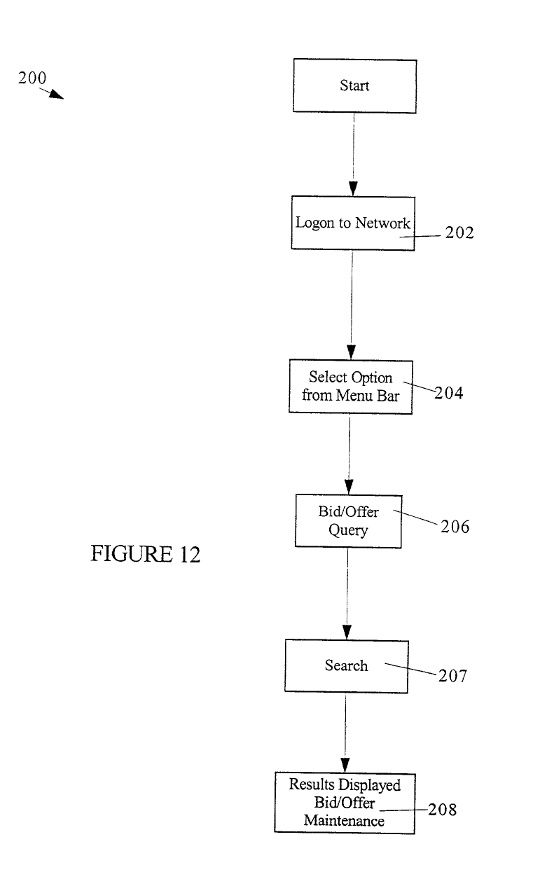

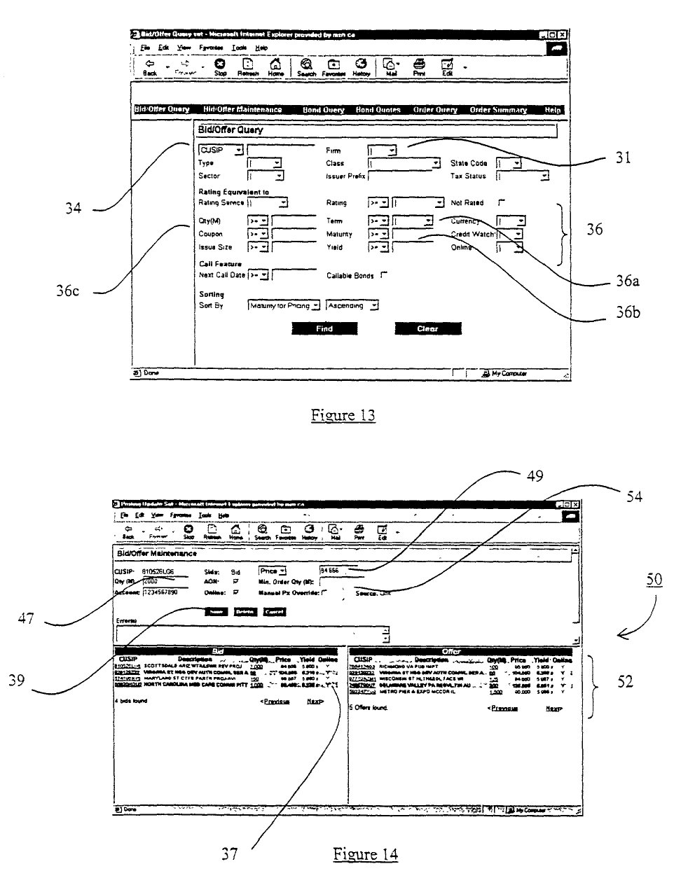

The listing of previous bids/offers made by the participant, preferably a client, can also be obtained by a bid/offer query. A method of effecting a bid/offer query is detailed in FIG. 12. The bid/offer query screen shown in FIG. 13 enables participants to search for specific bids and offers they posted against securities having a certain set of characteristics. The layout of the bid/offer query screen 33 is similar to that of the bond query screen 32 shown in FIG. 4. Results of a bid/offer query are displayed on the Bid/Offer Maintenance screen 50 as a postings summary 52 detailed in FIG. 14. This bid/offer query feature provides a participant with at least a listing of their personal bids or offers posted that meet the search criteria specified. However, in the case of an inventory administrator 14c shown in FIG. 1, the inventory administrator 14c views all bids and offers posted, meeting the criteria specified, associated with a plurality of participants. The inventory administrator 14c is not limited to viewing those bid/offers associated with the current participant.

When effecting a bid/offer query, the participant, preferably the liquidity provider, logs onto the system and passes through security features requiring the identification of that participant at 202, by any means known to one skilled in the art. Once logged onto the system, the participant selects an option from the available options 204on the menu bar detailed in FIG. 2. As illustrated in FIG. 12, the participant in this case selects bid/offer query as indicated at 206. On selecting bid/offer query, the system 10 returns the bid/offer query screen 33 and the participant is prompted to enter a set of search criteria 36. When specifying search criteria 36, the participant selects from the set of search criteria 36 illustrated in FIG. 13 which may include but is not limited to: term 36a, maturity 36b, coupon rate 36c etc.

An additional criteria specific to the participant being an inventory administrator 14c, is the ability to specify a firm identifier 31. The firm identifier is specific to a firm having one or more participants utilizing the bond network 16. On selecting a particular firm, the inventory administrator may view all bids and offers created by any participant at firm meeting the specified search criteria.

Once the participant has entered the desired search criteria 36 network 16 instructs at 207, the search engine 2b (as shown in FIG. 1) to search for any bid/offers posted meeting the specified search criteria and typically belonging to the current participant. However, in the case of an inventory administrator 14c, the system returns all bid/offers placed by any participant that meet the specified search criteria. When the search is complete, the system returns, at 208, a set of results displayed as a “postings summary” 52 on the bid/offer maintenance screen 50 as shown in FIG. 14. The postings summary 52 details all bids and offers placed by that participant or placed against a bond initially posted by that participant that meet the specified search criteria. In the event that no bids and/or offers match the search criteria, the system displays a message stating “no bid found” and/or “no offer found” on the bid/offer maintenance screen. In addition, when a participant specifies no search criteria, the system returns a list of all bids and offers created by that participant.

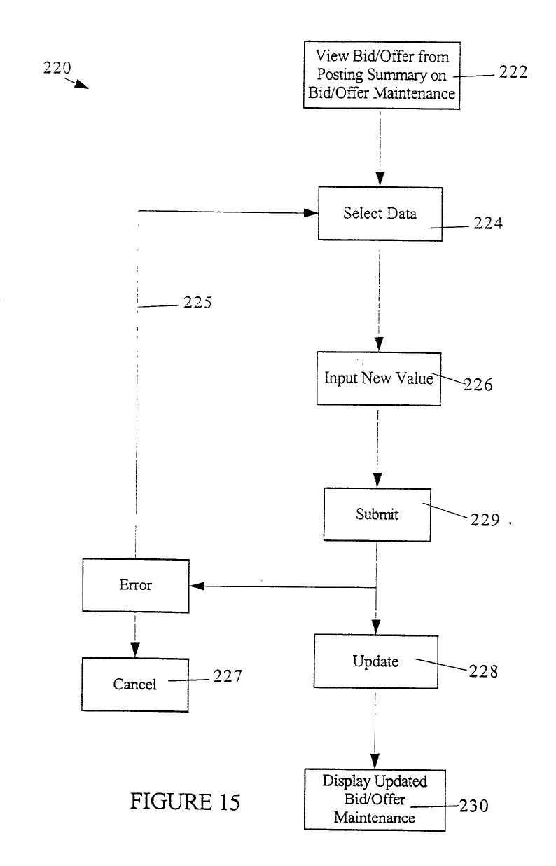

The bid/offer maintenance screen 50 also enables a participant to modify their own bid/offer postings and provides a method for updating those postings. A method of updating a posting 220 through the bid offer maintenance screen is detailed in FIG. 15. In order to maintain postings, a participant is able to modify a current bid/offer or delete a bid/offer created even in the event where orders are placed against it. All modifications are then reflected on the bond summary page, as shown in FIG. 5a. In addition, the bid/offer maintenance screen allows the participant to change the status 37 of their bids/offers between “online” and “offline”, as shown in FIG. 11, to allow the participant to make any changes to their bid/offer portfolio while no other participant is able to transact against a particular item in their portfolio.

When updating a bid/offer, a participant first reviews the postings summary 52 displayed 222 on the bid/offer maintenance screen 50 shown in FIG. 14. Then, on selection of a particular bid/offer 224 from the postings summary 52 the participant updates that bid/offer to reflect current market conditions, for example the price of a bid is adjusted to account for a drop in stock price. The participant selects the parameter to be updated and modifies the parameter through input of a new value 226. Modifications may include a change in the quantity 47 of the fixed income security offered or price of the fixed income security quoted 49.

Once the parameter has been updated, the participant then selects the “save” icon 39 from the bid/offer maintenance screen and the update is submitted 229 to the system. On saving the new value, the transaction engine 24 interacts with the rules datastore 22 to ensure the update to the bid/offer does not violate any system rules. In the event that the updated bid/offer violates a rule the system returns an error message at 41 and the participant is returned to the bid/offer maintenance screen 225 reflecting the original postings, or alternatively, the action may be cancelled 227. Once the participant submits the new information, if no error is returned, the system updates the posting 228 and then returns the participant to the bid/offer maintenance screen 230 reflecting the updated posting.

A participant may also update, modify or specify rules associated with a particular bid/offer, for example placing a requirement for a minimum order quantity 54, such that any bid or offer placed against that security must have a requested quantity greater than the minimum value specified. Once the update is complete, the bid/offer maintenance screen 50 is refreshed so as to automatically reflect updates to the postings summary 52 and the current status of each bid/offer. When the participant is an inventory administrator 14c, they have the further ability to change the status of all bid/offers relating to an entire firm as opposed to those bid/offers relating to a single participant.

Given the nature of the securities markets, fluctuations relating to the value of securities are expected. A particularly useful feature of the system is the ability of a participant to turn all their bids and offers, those created by themselves, from “online” to “offline”. For example, in the case where a marked increase or decrease in a particular fixed income security is expected, leaving the status of all bids and offers relating to that security “online” may leave the security under or over-valued. By electing to turn all the bid/offers relating to that security “offline”, a participant has the ability to modify the characteristics of a particular bid/offer to compensate for market fluctuations without a third party having the ability to transact against items in that participants portfolio relating to that security. Once the modification is completed, all bids and offers may be returned from “offline” to “online” status and the posting in the database 21 is updated.

In the preferred embodiment, the order entry feature 17g enables a participant to negotiate the price of the security for which the order is placed. If the bond network 16 has been configured to allow price negotiation, the order mode 67 may be selected by the participant. In order to enable price negotiation, the participant selects “Special Price” Alternatively, if there is no provision for price negotiation the order mode 67 states “Regular” as shown in FIG. 7a, and may not be modified by the participant.

The creation of a bid/offer or placement of an order may include the provision for price negotiation. In this case, the pricing engine 18 is configured to facilitate a price negotiation between participants. This feature enables a participant to perform 2-way online negotiation, for example with a trader 12d shown FIG. 1, to reach an agreement on a price for a particular fixed income security. The price negotiation feature is configurable on a site installation basis. The price negotiation feature is illustrated on the order details screen in FIG. 16 where the participant has the option to modify the price and place counter offers.

When a first participant elects to place for example, an order, the price negotiation feature enables that participant to select the order mode 67 special pricing on the order entry screen 60. On selecting the special pricing mode, the network 16 returns an order entry screen that allows the current participant to place an order at a price different from that price assigned to the fixed income security once the order has been placed, the quantity of the particular security available is adjusted by the system to reflect that this order has been placed. The network 16 then sends the order to the transaction engine 24 which interacts with the pricing engine 18 and rules datastore 22 as described above in relation to order entry. In the event that a warning is generated by the network 16, the status of the order 66 is forced to ‘pending’. When no warnings are found, the status of the order 66 is forced to ‘special price trade’. A second participant, generally a trader, receives and reviews the order modified price on behalf of or as the owner or liquidity provider, and has an option to make a counter-offer by changing for example, the price of the order, and then changing the order status 66 to show “counter-offer” as shown in FIG. 16. After modifying the price, the second participant selects the update feature 70 to calculate the new yield value. Once the counter-offer has been placed by the second participant, the system prompts the order status 66 to display the presence of a counter offer to the first participant. When the order status 66 shows the presence of a counter-offer, the first participant may elect to accept 69 or reject 68 the counter offer. Alternatively, the participant may place a further counter offer by again modifying the order price. The first participant, after changing the price selects the counter icon 65 and the system again indicates the presence of a counter offer to the second participant. This process continues until the order price is accepted by the first participant who placed the initial order. At this point the order status 66 is forced by the system to ‘pending’.

At this point, the second participant reviews the completed negotiation and the order is then either finalized or disapproved. When an order is finalized, the second participant accepts the order price offered by the first participant, negotiations are concluded, and the trade is posted as described above. If an order is disapproved by the second participant, the first participant may respond with further negotiations by proposing another price or cancel the order. The negotiation process is completed when the second participant either accepts or rejects the order proposed by the first participant. If an order is rejected and the order is disapproved, the order will not be contracted such that the order is not posted by the system. At this point, the status 66 of the order is changed to ‘disapproved’. The system then facilitates any inventory adjustments that had been made on account of this order being placed.

When an order is accepted the system posts the particulars of the bid/offer and the trade is transacted. Typically, a back office 15 settles the particulars of the trade pertaining to settlement booking and monetary exchange. The system may be customized such that at the end of a day, the system may cancel all orders that are in the midst of negotiation. Throughout the negotiation process, if an order violates a system rule, a warning will force the order to the pending status such that the error may be corrected as described above. In addition, both participants in a negotiation may elect to view the price history pertaining to the fixed income security under negotiation and view all the price and quantity changes that have occurred throughout the negotiation. The price history (not shown) feature is only available when the price negotiation feature is configured.

The system allows a participant, when posting inventory to specify a particular rule(s) that applies to that particular security when posted. For example, a rule may be applied to specific set of fixed securities and may stipulate a certain price yield formula to be used in calculations; or a rule may specify a maximum order quantity, etc. In addition, the system often has a set of rules within the rules database associated with the various types of participants. For example, an inventory administrator 14c cannot create a new bid/offer or an order. Inventory administrators oversee the network and are not intended to be active participants. They are able to view the source of bids/offers placed on a posting summary grid. External users, such as direct retail clients 12e and institutional clients 12a, typically view only the bid/offer details and not the source or owner of that particular security. Order administrators are internal clients and they view details pertaining to a plurality of participants and further may view both the bid/offer details and the source.

Alternatively, after an order has been posted, the order may be placed in a pending orders database. These pending offers preferably require approval prior to be transacted. This feature may be selectable on a site by site basis with it rules also being designated on a site by site basis.

It will be understood that the updates are performed in a real-time setting so that current offer/bid information may be transmitted and displayed to participants. By providing near real time updates, participants are able to fully appreciate the action occurring with respect to each bond, or fixed income security.

Although the invention has been described with reference to certain specific embodiments, various modifications thereof will be apparent to those skilled in the art without departing from the spirit and scope of the invention as outlined in the claims appended hereto. The Embodiments of the Invention in which an Exclusive Property or Privilege is Claimed are Defined as Follows:

1. A fixed income securities trading system for facilitating the negotiation and exchange of fixed income securities over an open network between a plurality of participants wherein, the trading system comprises:
a bond network having a search engine, a rules datastore, a pricing engine, a transaction engine and a fixed income securities database comprised a plurality of bids and offers;
a pair of participants where at least one participant is a liquidity provider; and
a datastore;
wherein at least one of said search engine and said transaction engine correlates criteria defined by one of said participants to said bond database as requested by said participant and where at least one of said search engine and said transaction engine interact with said rules datastore on each of said participant request within said bond network; and
wherein said bond network enables said participants to transact against one of a bid or offer posted in said fixed income securities database so as to facilitate the exchange of fixed income securities between said participants.

2. The fixed income securities trading system of claim 1, wherein said system further includes an interface to a third party fixed income securities provider.

3. The fixed income securities trading system of claim 1, wherein said participant defined criteria enable said participant to search said fixed income securities database so as to return a bid/offer list meeting said set of participant defined criteria.

4. The fixed income securities trading system of claim 3, wherein said bid/offer list includes a best bid and offer price for each of said items within said bid/offer list.

5. The fixed income securities trading system of claim 3, wherein when selecting one of said items of said bid/offer list returns a bond depth summary detailing all bids and offers relating to said selected item selected.

6. The fixed income securities trading system of claim 1, wherein each fixed income security with said fixed income securities database has a unique identifier.

7. The fixed income securities trading system of claim 1, wherein said liquidity provider posts inventory comprising bids and offers relating to a fixed income security stored in said fixed income securities database and where each of said bids and offers posted are unique to said liquidity provider.

8. The fixed income securities trading system of claim 1, wherein bids and offers transacted by said bond network is validated against said rules datastore.

9. The fixed income securities trading system of claim 1, wherein said participants include clients and liquidity providers.

10. The fixed income securities trading system of claim 1, wherein said rules datastore is customizable.

11. The fixed income securities trading system of claim 1, wherein when an order is placed, said order must specify one of a price value or a yield value.

12. The fixed income securities trading system of claim 1, wherein each order placed by a user is stored in said datastore so as to provide a means for historical analysis and archiving.

13. The fixed income securities trading system of claim 1, wherein said pricing engine includes a plurality of algorithms from which said participant selects the method for price calculation.

14. The fixed income securities trading system of claim 13, wherein said pricing engine includes a price to worst algorithm.

15. The fixed income securities trading system of claim 1, wherein said system updates dynamically the best-priced bid and offer available when at least one of a new bid or offer is posted against a fixed income security, a change is made to the price or yield of posted bids and offers, and a change is made in quantity of said posted bids and offers.

16. The fixed income securities trading system of claim 1, wherein said pricing engine further includes a price negotiation mechanism.

17. The fixed income securities trading system of claim 1, an order transacted by said bond network is validated against said rules datastore.
